(19) United States
(12) Patent Application Publication
(10) Pub. No.: US 2025/0110568 A1
(43) Pub. Date: Apr. 3, 2025

(54) Pinch Compensation for Markup

(71) Applicant: Apple Inc., Cupertino, CA (US)

(72) Inventor: Alexander T. Wing, Fremont, CA (US)

(21) Appl. No.: 18/823,516

(22) Filed: Sep. 3, 2024

Related U.S. Application Data
(60) Provisional application No. 63/586,583, filed on Sep. 29, 2023.

(51) Int. Cl. G06F 3/01; G06V 40/20

(52) U.S. Cl. CPC G06F 3/017; G06V 40/28

(57) ABSTRACT

Generating markup from input gestures includes obtaining hand tracking data for a hand based on one or more camera frames, and detecting that, for a first frame, a threshold change in motion characteristics of the hand satisfies a threshold change. In response, a determination is made as to whether a change in pinch status is detected in a second frame within a threshold time of the first frame. In response to the change in pinch status occurring within the threshold time period of the first frame, a hand location is provided in the first frame for a user input action associated with the change in pinch status from the second frame.

### BACKGROUND

Some devices can generate and present Extended Reality (XR) Environments. An XR environment may include a wholly or partially simulated environment that people sense and/or interact with via an electronic system. In XR, a subset of a person's physical motions, or representations thereof, are tracked, and in response, one or more characteristics of one or more virtual objects simulated in the XR environment are adjusted in a manner that comports with realistic properties. Some XR environments allow multiple users to interact with virtual objects or with each other within the XR environment. For example, users may use gestures to perform markup functions. However, what is needed is an improved technique to manage tracking of a hand performing the gesture to enhance markup.

### BRIEF DESCRIPTION OF THE DRAWINGS

FIGS. 1A-1B show example diagrams of generating markup using hand tracking, in accordance with one or more embodiments.

FIG. 2 shows a flow diagram of a technique for detecting input gestures for markup, in accordance with some embodiments.

FIG. 3 shows a flowchart of a technique for initiating pinch compensation for markup, in accordance with some embodiments.

FIG. 4 shows a diagram for revising markup using pinch compensation based on a detected change in motion characteristics and pinch status, in accordance with some embodiments.

FIG. 5 shows a system diagram of an electronic device which can be used for gesture markup, in accordance with one or more embodiments.

FIG. 6 shows an exemplary system for use in various extended reality technologies.

### DETAILED DESCRIPTION

This disclosure pertains to systems, methods, and computer readable media to enable gesture recognition and input. In some enhanced reality contexts, image data and/or other sensor data can be used to detect gestures by tracking hand data, which can then be transformed into markup on a user interface (UI). Techniques described herein are directed to refine hand tracking data to cause the resulting markup to better capture user intent and adjust for latency. In particular, techniques described herein are directed to adjusting detected user input motion based on changes in pinch status, pinch progress, and/or motion characteristics in order to generate UI markup in order to account for missing data, latency, and other issues which may introduce inaccuracy into the resulting markup as compared to the intended markup as performed by the user.

When performing a markup gesture, hand tracking functions may use sensor data capturing one or more hands of a user to determine whether the hand is in a state to be generating markup or not. For example, pinched fingers may indicate that markup should be recorded, whereas a release of a pinch—or an “unpinch”—may indicate that markup should be ceased. Problems arise, for example, when a pinch or unpinch event is detected early or late. This may cause artifacts to be generated in the markup.

According to some embodiments, the markup may be generated more accurately by considering not only a change in pinch states (i.e., detecting a pinch event or unpinch event), but a change in motion characteristics of the hand. For example, hand tracking data may provide an estimation of a hand or joints of the hand, such as the pinch centroid. According to some embodiments, a pinch centroid can be determined for a hand for user input, such as markup. That is, the movement of the pinch centroid may be translated into markup on a UI. The motion characteristics of the pinch centroid may be provided by hand tracking, or may be determined based on location data for the pinch centroid over a series of frames. Further, in some embodiments, motion characteristics of another joint in the hand, wrist, or the like, may be used for determining motion characteristics of the hand. If a change in pinch status and a change in motion characteristics (for example, a sudden change in acceleration over a predefined threshold and/or satisfying a threshold parameter such as a change in direction or the like) occur within a predefined time period of each other, then the resulting markup may be amended. For example, if a change in motion characteristics occurs prior to a change in pinch status from an unpinch state to a pinch state, then the markup corresponding to the frames between the change in motion characteristics and the change in pinch status may be removed. Similarly, if a change in motion characteristics occurs prior to a change in pinch status from a pinch state to an unpinch state, then the location of the pinch centroid in the frames between the change in motion characteristics and the change in pinch status may be used to add markup. Said another way, if a change in pinch status occurs near a substantial change in motion characteristics, the point at which markup begins or ends is revised to coincide with a point at which the change in motion characteristics were detected.

In the following disclosure, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system-and business-related constraints) and that these goals may vary from one implementation to another. It will also be appreciated that such development efforts might be complex and time-consuming but would nevertheless, be a routine undertaking for those of ordinary skill in the design and implementation of graphics modeling systems having the benefit of this disclosure.

For purposes of this application, the term “markup” refers to drawing or other augmentation to a user interface corresponding to strokes performed by a user in the form of a persisted gesture.

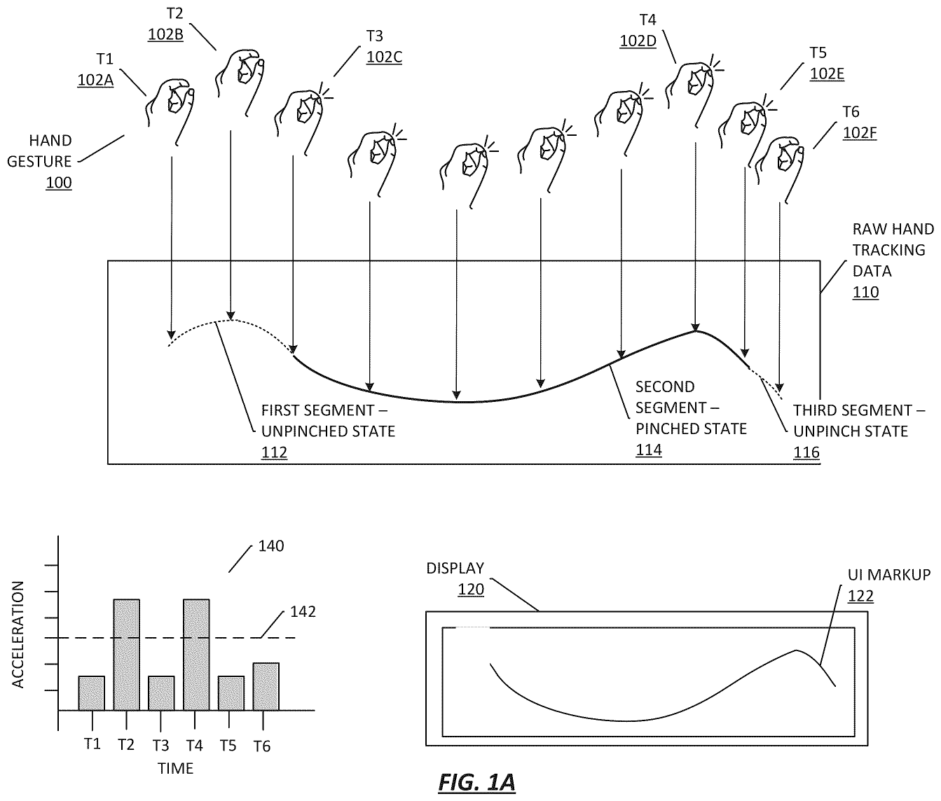

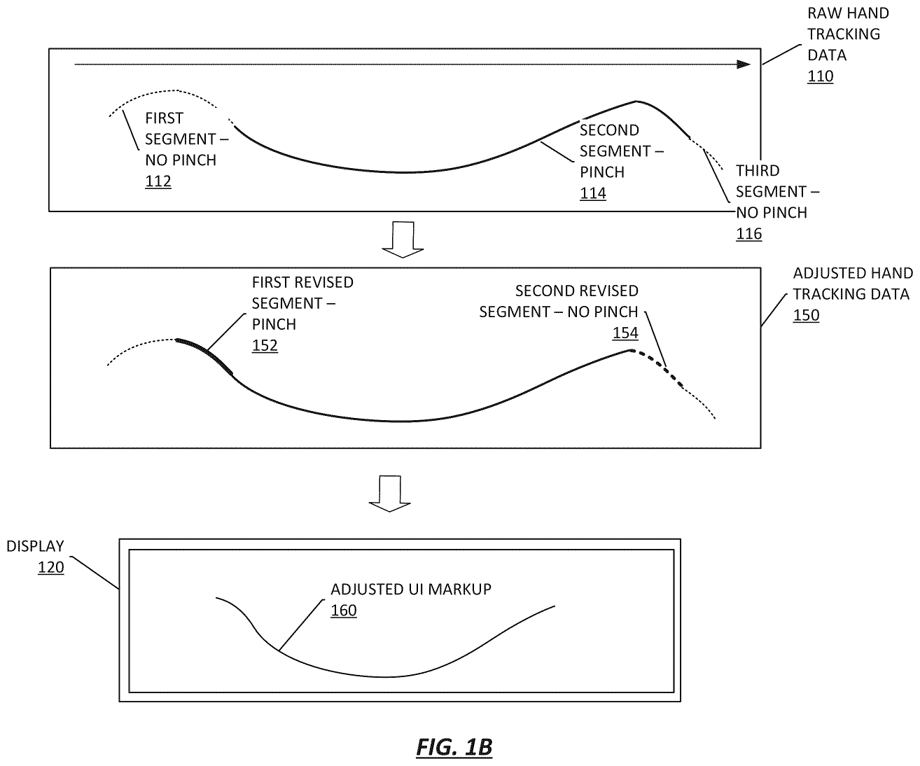

FIG. 1A shows a diagram of a technique for generating markup using a pinch gesture, in accordance with one or more embodiments. In particular, FIG. 1 depicts an example of a technique for translating a hand gesture into UI markup based on a detected pinch event, but without consideration of motion characteristics. Hand gesture 100 includes a series of hand poses which make up a pinch markup input. The selection of poses shown may be representative of the hand pose detected at the corresponding time, such as a pose captured in a camera frame at the corresponding time. Initially, at T1 102A, the hand is unpinched. Similarly, at T2 102B, the hand remains unpinched, but shifts directions. At T3 102C, the hand pose is shown in a pinched position. As a result, the raw hand tracking data 110 includes a first segment 112 in which the hand is determined to be in an unpinched state and, as a result, no markup is produced.

Between T3 102C and T4 102D, the hand gesture 100 includes an arced motion during which the hand is detected in a pinched state. At T4 102D, the hand again changes direction from an upward motion to a downward motion. T5 102E is the last frame in which the hand is recognized in a pinched state. As a result, the raw hand tracking data 110 include a second segment 114 in which the hand is determined to be in a pinched state, between T3 102C and T5 102E. Because the pinch is determined to be in a pinched state, markup may be generated. In some embodiments, the result markup reflects the motion of the hand, or a portion of the hand, while in the pinched state. For example, a pinch centroid may be determined based on a particular location relationship to a hand. For instance, the pinch centroid may be at a location at which two fingers, such as an index finger and thumb, make contact, or may be determined in another manner—such as an offset from a hand origin or other location. In some embodiments, the markup may be generated to reflect the motion of the pinch centroid.

At T6 102F, the hand is determined to be in an unpinched state. The raw hand tracking data 110 additionally includes a third segment 116, in which the hand is determined to be in an unpinched state and, as a result, the markup is ceased.

Display 120 depicts an example display device of an electronic device in which the markup generated by the hand gesture 100 is presented. Display 120 may be part of a multifunctional electronic device, such as a mobile device or a wearable device, or other electronic device comprising a display capable of presenting UI markup. Raw data UI markup 122 depicts a markup on a UI that results from the raw hand tracking data 110 taking into account pinch state but not motion characteristics. As shown, the shape of the markup aligns with the motion of the hand gesture 100 during the second segment 114 and include the arc captured between T3 102C and T4 102D, as well as the change in direction between T4 102D and T5 102E.

However, because the threshold change in motion characteristics of the hand (here, a change in velocity) at T2 is captured just prior to the pinch down at T3 102C, it is likely that the pinch down at T3 102C is a late-detected pinch, and the user intent was to begin the markup at T2 102B, where the threshold change in motion characteristics occurred. Similarly, the motion between T4 102D and T5 102E is captured as markup, but the change in motion characteristics at T4 102D occurs just before a change in pinch status at T5 102E. As such, the resulting raw data UI markup 122 includes hooking element at the end of the markup which is likely unintentional and due to latency, user error, or the like.

Bar graph 140 of FIG. 1A shows an example determined change in velocity at each time identified in the motion of the hand gesture 100. In particular, bar graph 140 shows a change in velocity of the hand in the form of an acceleration measure at each identified time as compared to a threshold motion characteristic in the form of threshold acceleration 142. Accordingly, a threshold change in motion characteristics are detected at T2 102B and T4 102D.

Turning to FIG. 1B, an example diagram is presented in which the markup is modified based on adjusted hand tracking data, in accordance with one or more embodiments. In particular, FIG. 1B depicts an example of a technique for translating a hand gesture into UI markup based on a detected pinch event, with consideration of motion characteristics. As described above with respect to FIG. 1A, the raw hand tracking data 110 includes a first segment 112 in which the hand is determined to be in an unpinched state and, as a result, no markup is produced. In addition, the raw hand tracking data 110 include a second segment 114 in which the hand is determined to be in a pinched state, and markup corresponding to the hand movement may be generated. Further, the raw hand tracking data 110 includes a third segment 116, in which the hand is determined to be in an unpinched state and, as a result, the markup is ceased.

According to one or more embodiments, the markup may be adjusted in accordance with a determination that a chance in pinch status and a change in motion characteristics that satisfies a threshold occur within a predetermined time. For example, citing back to FIG. 1A, because the in motion characteristics at T2 102B is captured just prior to the pinch down at T3 102C, it is likely that the pinch down at T3 102C is a late-detected pinch, and the user intent was to begin the markup at T2 102B, where the change in motion characteristics occurred. Similarly, the motion between T4 102D and T5 102E is captured as markup as shown with the hook down at the end of the raw data UI markup 122, but the change in motion characteristics at T4 102D occurs just before a change in pinch status at T5 102E indicating that the intended markup action began at T4 102D.

For purposes of the example of FIGS. 1A-1B, it may be determined that the change in motion characteristics at T2 102B and the change in motion characteristics at T4 102D each satisfied a threshold change in motion characteristics monitored to determine whether to adjust markup. In addition, it may be determined that the change in motion characteristics at T2 102B and the detected pinch down at T3 102C occurred within a predefined time period. According to one or more embodiments, a determination that a change in motion characteristics satisfying threshold motion characteristics, and a change in pinch status occurring within a predefined period indicates that a resulting markup should be adjusted. If the change in pinch status is detected after the change in motion characteristics, it may be determined that the pinch was detected late, or that the user inadvertently pinched late. As a result, the system may determine that the resulting markup should be adjusted to capture the missed movement of the hand. As shown here, the motion from the hand tracking data is adjusted at the first revised segment 152 to indicate a touch. Although the adjustment is depicted in FIG. 1B as being applied to the hand tracking data (e.g., raw hand tracking data 110 as compared to adjusted hand tracking data 150), in some embodiments, the adjustment may be made on the markup itself (e.g., raw data UI markup 122), as shown adjusted UI markup 160. As such, the resulting adjusted UI markup 160 now begins earlier than the raw data UI markup 122. In some embodiments, the adjusted UI markup 160 is adjusted by obtaining location information for the hand, such as position information for the pinch centroid, for the frames between the threshold change in velocity and the change in pinch status. This positional information is used to generate the portion of the markup which may not initially be captured based on the raw hand tracking data. For example, the position of the hand may be translated into markup for presentation on the display 120. As such, in some embodiments, initially the portion of the markup corresponding to the second segment 114 may be displayed prior to the portion of the markup associated with the first revised segment 152.

Further, it may be determined that the change in motion characteristics at T4 102D occurs within a predefined time period of the change in pinch status at T5 102E. According to one or more embodiments, because the change in pinch status is detected after the change in motion characteristics, it may be determined that the unpinch event was detected late, or that the user unintentionally unpinched late. For example, a user may intend to end a markup and suddenly drop their hand, but the unpinch occurs during the drop rather than at the initiation of the drop. As a result, the system may determine that the resulting markup should be adjusted to remove the extraneously captured movement of the hand. As shown here, the motion from the hand tracking data is adjusted at the second revised segment 154 to indicate no pinch is occurring. Although the adjustment is depicted in FIG. 1B as being applied to the hand tracking data (e.g., raw hand tracking data 110), in some embodiments, the adjustment may be made on the markup itself (e.g., raw data UI markup 122), as shown adjusted UI markup 160. As such, the resulting adjusted UI markup 160 now ends earlier than the original raw data UI markup 122, as is apparent from the missing hooking feature at the end of adjusted UI markup 160. In some embodiments, the adjusted UI markup 160 is adjusted by obtaining location information for the hand, such as position information for the pinch centroid, for the frames between the threshold change in velocity and the change in pinch status. This positional information is used to remove the portion of the markup which was originally determined to be used for markup based on pinch status without regard for motion characteristics changes. As such, in some embodiments, initially the portion of the markup corresponding to the second revised segment 154 may be displayed prior to the removal of the associated markup. In some embodiments, variations may used to adjust markup. For example, if a user is generally moving slowly, the threshold change in motion characteristics may differ than if a user is generally moving faster. As another example, if a user's motion is below a threshold velocity generally, the pinch and uncinch may be considered to be more precise and markup may not be adjusted.

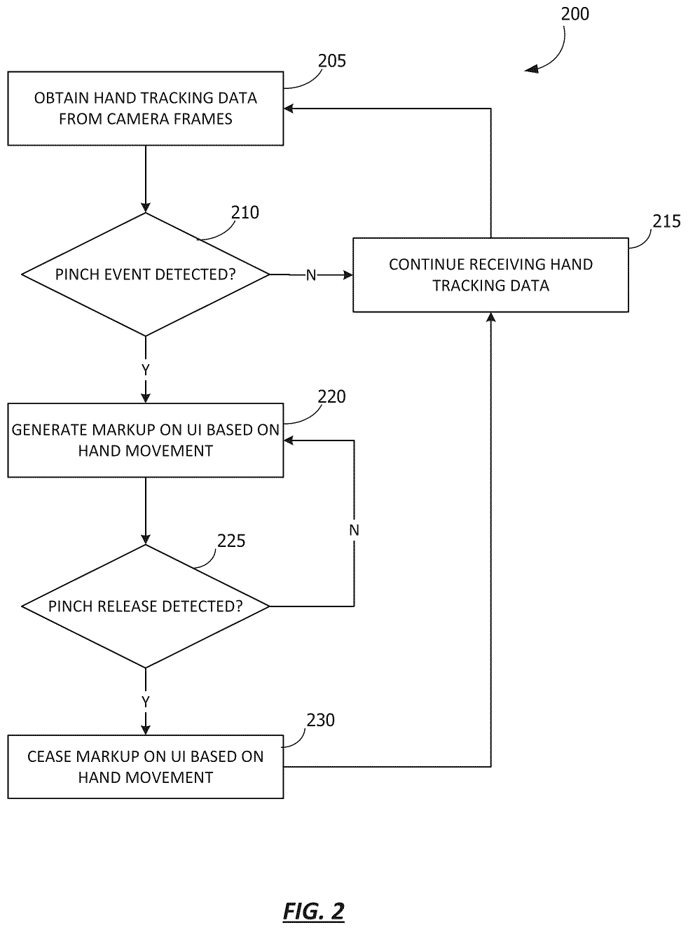

FIG. 2 shows a flow diagram of a technique for generating markup using input gestures such as a pinch, in accordance with some embodiments. In particular, FIG. 2 shows a flowchart of a method for generating markup based on hand movement and detected pinches without consideration of a threshold change of motion characteristics. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 200 begins at block 205, where hand tracking data is obtained from camera frames or other frames of sensor data. The hand tracking data may include, for example, image data, depth data, and the like, from which hand pose, position, and/or motion can be estimated. In some embodiments, the hand tracking data may include or be based on additional sensor data, such as image data and/or depth data captured of a user's hand or hands. In some embodiments, the sensor data may be captured from sensors on an electronic device, such as outward facing cameras on a head mounted device, or cameras otherwise configured in an electronic device to capture sensor data including a user's hands. In some embodiments, the sensor data may include additional data collected by an electronic device and related to the user. For example, the sensor data may provide location data for the electronic device, such as position and orientation of the device.

The flowchart 200 continues at block 210, where a determination is made as to whether a pinch is detected. Pinch detection may rely on a hand pose determination from the hand tracking data. In some embodiments, the hand pose may be determined estimation based on predicted locations of one or more joints of the hand. For example, a hand tracking network may provide estimated locations of each of a set of joints of the hand. In some embodiments, a hand pose may be determined based on a relative location of a set for subset of these joints. Additionally, or alternatively, a gap distance between two fingers such as the index finger and the thumb may be used to determined whether a pinch occurs. The gap distance may be measured in the sensor data or predicted based on the sensor data. Upon determination that the gap distance is determined to be within a predetermined threshold, and/or if the hand pose satisfies a pinch parameter, then a pinch down event is determined to have occurred, such as a “pinch down.” If at block 210, a pinch event is not detected, then the flowchart proceeds to block 215, and the system continues to receive hand tracking data without generating markup.

Returning to block 210, if a determination is made that a pinch event is detected, then the flowchart 200 proceeds to block 220. At block 220 markup is generated on a UI based on the hand movement. According to one or more embodiments, markup is generated by applying digital or virtual ink in a manner consistent with a stroke of the hand while a markup gesture is active. For example, while the pinch is detected, the stroke or motion of the hand or part of the hand will be tracked and translated into a markup on a user interface. According to one or more embodiments, the markup is generated based on a position of a portion of the hand during the input gesture. According to one or more embodiments, a pinch centroid is a point in space which is tracked for determining user input using a pinch. The pinch centroid may be determined based on characteristics of the position and orientation of the hand. For example, the pinch centroid may be determined at a particular offset including a distance and angle from a particular location on the hand in accordance with a pose of the hand.

As additional frames of sensor data are received, the markup is generated in accordance with the corresponding hand position. As such, the flowchart 200 proceeds to block 225, where a determination is made as to whether a pinch release is detected (e.g., a “pinch up” even). According to one or more embodiments, the determination as to whether a pinch release is detected may be based on a predicted gap distance exceeding a predefined threshold, and/or a touch no longer being predicted between two fingers (such as the index finger and thumb). While a pinch release is not detected, the flowchart 200 returns to block 220 and the system continues to generate markup corresponding to the hand position of the user.

Returning to block 225, if a determination is made that a pinch release is detected, then the flowchart proceeds to block 230, and the system ceases markup on the UI based on the hand movement. That is, the movement of the hand is no longer used to generate markup on the UI. The flowchart 200 then returns to block 215, and the system continues to receive hand tracking data until a next pinch event is detected.

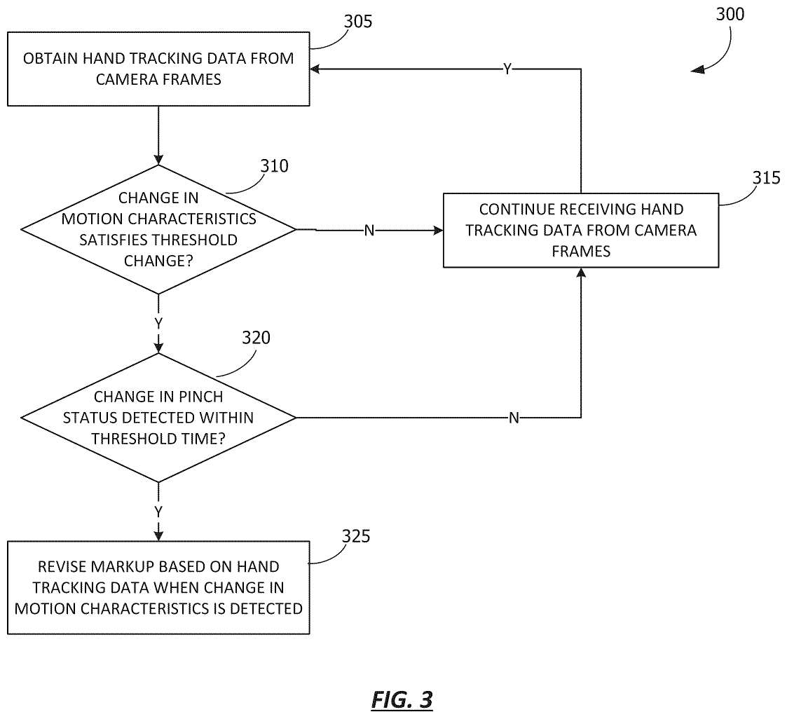

Turning to FIG. 3, a flowchart of a technique for generating markup using input gestures, in accordance with some embodiments. In particular, FIG. 3 shows a flowchart of a method for generating markup based on hand movement and detected pinches with consideration of a threshold change of motion characteristics. In accordance with some embodiments, the flowchart of FIG. 3 is performed in conjunction with the flowchart described above with respect to FIG. 2. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 300 begins at block 305, where hand tracking data is obtained from camera frames or other frames of sensor data. The hand tracking data may include, for example, image data, depth data, and the like, from which hand pose, position, and/or motion can be estimated. In some embodiments, the hand tracking data may include or be based on additional sensor data, such as image data and/or depth data captured of a user's hand or hands. In some embodiments, the sensor data may be captured from sensors on an electronic device, such as outward facing cameras on a head mounted device, or cameras otherwise configured in an electronic device to capture sensor data including a user's hands. In some embodiments, the sensor data may include additional data collected by an electronic device and related to the user. For example, the sensor data may provide location data for the electronic device, such as position and orientation of the device.

The flowchart 300 continues at block 310, where a determination is made as to whether motion characteristics of a hand satisfies a threshold change in motion characteristics. As described above, a change in motion characteristics that occurs near a change in pinch status may be more indicative of an intent to begin or end markup than a change in pinch status alone. The motion characteristics may indicate one or more differences in the motion characteristics, such as sudden acceleration, deceleration, change in direction, or the like, which satisfy a threshold change in motion characteristics indicating intent by the user to either begin or end markup. Examples of the change in motion characteristics may include, for example, a sudden drop of the hand, a “hooking back” motion where the hand quickly changes direction, or the like. Other examples include the hand suddenly acceleration past a predefined threshold acceleration, decelerating below a predefined threshold deceleration, or the like.

According to one or more embodiments, the determination of the change in motion characteristics at block 310 may occur synchronously or asynchronously with the determination that a pinch event is detected, as described above with respect to block 210 of FIG. 2. That is, a particular frame may be analyzed to determine whether a pinch event is detected based on a current frame and/or one or more additional frames. In some embodiments, the same frame is then analyzed to determine a change in motion characteristics, for example using the same set of frames used to detect a pinch event, or an alternative set of frames. Alternatively, the determination that the change in motion characteristics satisfies a velocity parameter may occur later in the pipeline such that the method depicted in FIG. 3 occurs in response to detecting a change in pinch status. If at block 310, a change in velocity satisfying a threshold change is not detected, then the flowchart proceeds to block 315, and the system continues to receive hand tracking data.

Returning to block 310, if the change in motion characteristics does not satisfy the threshold change, then the flowchart 300 continues to block 320, where a determination is made as to whether the change in pinch status is detected within a threshold time period of the change in motion characteristics from block 310. As described above, according to one or more embodiments, a change in pinch status that occurs in close proximity to a detected change in motion characteristics, but not concurrently, may indicate that the pinch or unpinch was either detected early or late. Accordingly, the threshold time period may include a time period before and/or after the detected change in pinch status. In some embodiments, the threshold time period may be constant, or may be dynamic based on user preference, contextual factors, or the like. For example, in some embodiments the threshold time period may be application specific. Moreover, the threshold time period may be dynamically modified based on other factors, such as hand velocity, other components on a user interface, or the like. If at block 320, determination is made that the change in pinch status is not detected within the threshold time period, then the flowchart proceeds to block 315, and the system continues to receive hand tracking data.

If, at block 320, a determination is made that the change in pinch status is detected within the threshold time period, then the flowchart 300 concludes at block 325. At block 325, the market is revised based on the hand tracking data from the point at which the threshold change in motion characteristics was detected. For example, if a pinch down is detected just before a threshold change in motion characteristics and within the threshold time period, then a corresponding markup may be revised to remove markup that was generated in association with the frames of hand tracking data between the detected pinch down and the detected threshold change motion characteristics. That is, the pinch may be determined to have occurred earlier than the user intended, resulting in excess markup. As another example, if the pinch down is detected within a predefined time period of the threshold change in motion characteristics, then a corresponding markup may be revised to add markup to a UI in accordance with hand tracking data captured in the frames between the detected threshold change in motion characteristics and the change in pinch status. That is, the pinch down may be determined to have been detected late, resulting in missing markup.

Similarly, if a pinch up is detected just before the change in motion characteristics and within the threshold time period, then a corresponding markup may be revised to add markup that was generated in association with the frames of hand tracking data between the detected pinch up and the detected change motion characteristics. That is, the pinch up may be determined to have occurred earlier than the user intended, resulting in missing markup. As another example, if the pinch up is detected just after the change in motion characteristics and within a predefined time period, then a corresponding markup may be revised to remove markup to a UI in accordance with hand tracking data captured in the frames between the detected change in motion characteristics and the change in pinch status. That is, the pinch up may be determined to have been detected late, resulting in excess markup.

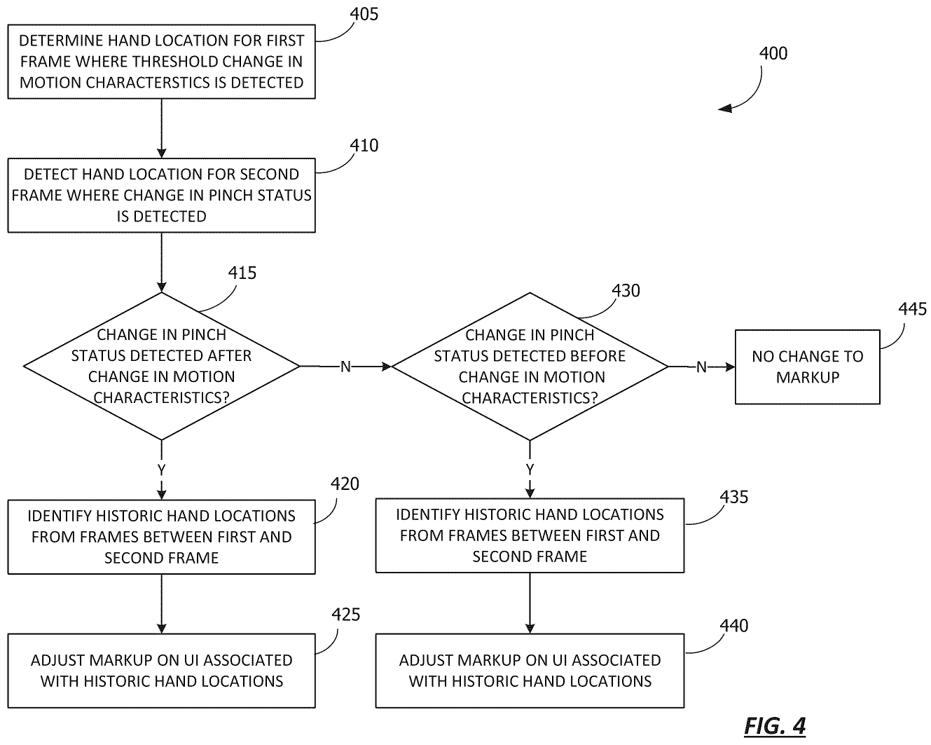

FIG. 4 shows a diagram for revising markup based on motion characteristics and pinch status, in accordance with some embodiments. In particular, FIG. 4 depicts in greater detail how markup is adjusted based on a change in pinch status and a threshold change in motion characteristics, for example as described above in block 325 of FIG. 3. For purposes of explanation, the following steps will be described as being performed by particular components. However, it should be understood that the various actions may be performed by alternate components. The various actions may be performed in a different order. Further, some actions may be performed simultaneously, and some may not be required, or others may be added.

The flowchart 400 begins at block 405, where a hand location is determined for a first frame where the change in motion characteristics satisfying the threshold change in motion characteristics is detected. According to one or more embodiments, the hand location can be determined in a 2D or 3D coordinate system using tracking techniques by an electronic device. In some embodiments, the hand location may be determined using hand tracking data captured by a user-wearable device such as a head mounted device. In some embodiments, sensor data is captured corresponding to movements and characteristics of the hands and is fed into a hand tracking pipeline which provides data related the location of the hand, pose of the hand, or the like. The location of the hand may be provided, for example, in a user-centric coordinate system, and the movement through the coordinate system may be translated to generate UI markup.

The flowchart continues to block 410 where a hand location is determined for a second frame where the change in pinch status is detected. According to one or more embodiments, the change in pinch status may additionally be determined by the hand tracking pipeline using the same sensor data or different sensor data than that used to determine the hand location. Although blocks 405 and 410 are depicted in a particular order, it should be understood that in some embodiments, the frame corresponding to the change in pinch status may temporally be captured prior to the frame corresponding to the threshold change in motion characteristics. Further, although the flowchart describes the frames as “first” and “second” frames, it should be understood that this designation merely indicates that the frames are two different frames. Further, the first frame and the second frame may or may not be consecutive frames. That is, the first frame may be captured some time before the second frame, or the second frame may be captured some time before the first frame.

At block 415, a determination is made as to whether the change in pinch status is detected after the threshold change in motion characteristics. That is, a determination is made as to whether the second frame from block 410 was temporally captured after the first frame from block 405. If a determination is made at block 415 that the change in pinch status is detected after the threshold change in motion characteristics, then the flowchart continues to block 420, where historic hand locations are identified from the frames between the first frame at block 405 and second frame at block 410. According to one or more embodiments, a record is stored of hand locations for each frame. In other embodiments, the historic hand locations may be determined for prior frames based on historic hand tracking data. As such, the system can reference the historic hand locations for each frame between the first frame and the second frame. In some embodiments, the hand locations may be determined in a coordinate system associated with the user, the device, or the like. The flowchart then concludes at block 425, where the markup is adjusted on the UI based on the historic hand locations. That is, if the change in pinch status involved a change from a pinch to unpinch, and the change in pinch status was detected after the threshold change in motion characteristics, the historic hand locations identified at block 420 can be referenced against the resulting markup to remove the markup corresponding to those hand locations. Similarly, if the change in pinch status involved a change from unpinch to pinch, and the change in pinch status was detected after the threshold change in motion characteristics, the historic hand locations identified at block 420 can be referenced against the resulting markup to add the markup corresponding to those hand locations.

Returning to block 415, if a determination is made that the change in pinch status is not detected after the threshold change in motion characteristics, then the flowchart continues to block 430, where a determination is made regarding whether the change in pinch status is detected before the threshold change in motion characteristics. Although decision blocks 415 and 430 are shown in a particular order, it should be understood that the decisions may be made in a different order or simultaneously.

If a determination is made at block 430 that the change in pinch status is detected as occurring before the threshold change in motion characteristics, the flowchart proceeds to block 435, where historic hand locations are identified from the frames between the first frame at block 405 and second frame at block 410. According to one or more embodiments, a record is stored of hand locations for each frame. In other embodiments, the historic hand locations may be determined for prior frames based on historic hand tracking data. As such, the system can reference the historic pinch locations for each frame between the first frame and the second frame. In some embodiments, the hand locations may be determined in a coordinate system associated with the user, the device, or the like. The flowchart then concludes at block 440, where the markup is adjusted on the UI based on the historic hand locations. That is, if the change in pinch status involved a change from a pinch to unpinch, and the change in pinch status was detected before the threshold change in motion characteristics the historic hand locations identified at block 420 can be used to retroactively add additional markup to the markup already generated or determined to be generated on the UI corresponding to those hand locations. Similarly, if the change in pinch status involved a change from pinch to unpinch, and the change in pinch status was detected after the threshold change in motion characteristics, the historic hand locations identified at block 420 can be referenced against the resulting markup to remove the markup corresponding to those hand locations.

Returning to block 430, if a determination is made that the change in pinch status is not detected before the threshold change in motion characteristics, then the flowchart concludes at block 445, and no changes are made to the markup. That is, markup is modified when the pinch status change and threshold change in motion characteristics occur shortly before or after each other. If a determination is made at block 430 that the change in pinch is not detected as occurring before the threshold change in motion characteristics, and a determination was made at block 415 that the change in pinch is not detected as occurring after the threshold change in motion characteristics, then the two events may occur at the same or similar time. When the change in pinch status and the threshold change in motion characteristics are determined to occur at the same or similar time, the flowchart concludes at block 445, and no change is made to the markup. That is, when the change in pinch status and the threshold change in motion characteristics are determined to occur at the same or similar time, a determination can be made that the user intent matches the markup.

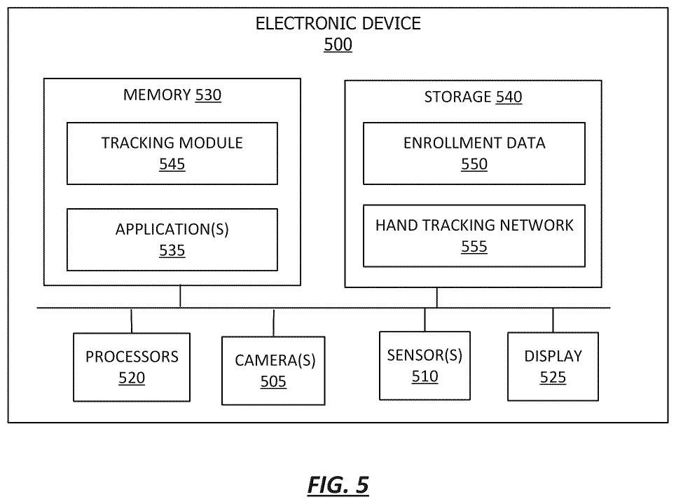

Referring to FIG. 5, a simplified block diagram of an electronic device 500 is depicted. Electronic device 500 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 500 may include one or more additional devices within which the various functionality may be contained or across which the various functionality may be distributed, such as server devices, base stations, accessory devices, etc. Illustrative networks include, but are not limited to, a local network such as a universal serial bus (USB) network, an organization's local area network, and a wide area network such as the Internet. According to one or more embodiments, electronic device 500 is utilized to interact with a user interface of an application 535. According to one or more embodiments, application(s) 535 may include one or more editing applications, or applications otherwise providing editing functionality such as markup. It should be understood that the various components and functionality within electronic device 500 may be differently distributed across the modules or components, or even across additional devices.

Electronic Device 500 may include one or more processors 520, such as a central processing unit (CPU) or graphics processing unit (GPU). Electronic device 500 may also include a memory 530. Memory 530 may include one or more different types of memory, which may be used for performing device functions in conjunction with processor(s) 520. For example, memory 530 may include cache, ROM, RAM, or any kind of transitory or non-transitory computer-readable storage medium capable of storing computer-readable code. Memory 530 may store various programming modules for execution by processor(s) 520, including tracking module 545, and other various applications 535. Electronic device 500 may also include storage 540. Storage 540 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 540 may be utilized to store various data and structures which may be utilized for storing data related to hand tracking and UI preferences. Storage 540 may be configured to store hand tracking network 555, and other data used for determining hand motion, such as enrollment data 550, according to one or more embodiments. Electronic device may additionally include a network interface from which the electronic device 500 can communicate across a network.

Electronic device 500 may also include one or more cameras 505 or other sensors 510, such as a depth sensor, from which depth of a scene may be determined. In one or more embodiments, each of the one or more cameras 505 may be a traditional RGB camera or a depth camera. Further, cameras 505 may include a stereo camera or other multicamera system. In addition, electronic device 500 may include other sensors which may collect sensor data for tracking user movements, such as a depth camera, infrared sensors, or orientation sensors, such as one or more gyroscopes, accelerometers, and the like.

According to one or more embodiments, memory 530 may include one or more modules that comprise computer-readable code executable by the processor(s) 520 to perform functions. Memory 530 may include, for example, tracking module 545, and one or more application(s) 535. Tracking module 545 may be used to track locations of hands and other user motion in a physical environment. Tracking module 545 may use sensor data, such as data from cameras 505 and/or sensors 510. In some embodiments, tracking module 545 may track user movements to determine whether to trigger user input from a detected input gesture, such as markup functionality. Electronic device 500 may also include a display 525 which may present a UI for interaction by a user such as presenting markup generated by a tracked gesture. The UI may be associated with one or more of the application(s) 535, for example. Display 525 may be an opaque display or may be semitransparent or transparent. Display 525 may incorporate LEDs, OLEDs, a digital light projector, liquid crystal on silicon, or the like.

Although electronic device 500 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, some combination of the functionality of any of the components may be combined.

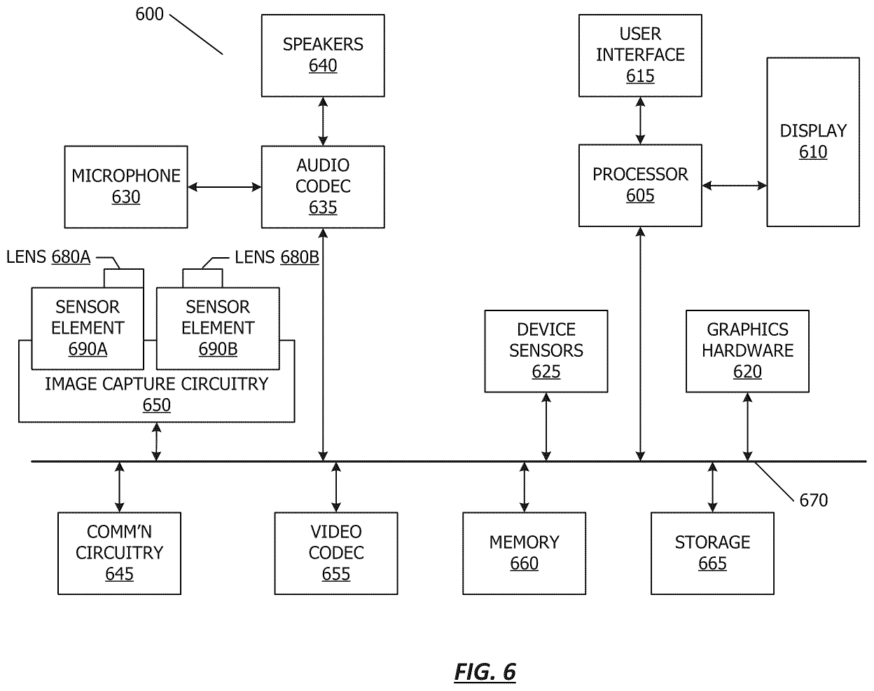

Referring now to FIG. 6, a simplified functional block diagram of illustrative multifunction electronic device 600 is shown according to one embodiment. Each of electronic devices may be a multifunctional electronic device or may have some or all of the described components of a multifunctional electronic device described herein. Multifunction electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system), video codec(s) 655 (e.g., in support of digital image capture unit), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen, touch screen, gaze, and/or gestures. Processor 605 may also, for example, be a system-on-chip such as those found in mobile devices and include a dedicated GPU. Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor elements 690A and 690B. Alternatively, two or more lens assemblies may share a common sensor element. Image capture circuitry 650 may capture still and/or video images. Output from image capture circuitry 650 may be processed by video codec(s) 655 and/or processor 605 and/or graphics hardware 620, and/or a dedicated image processing unit or pipeline incorporated within circuitry 650. Images so captured may be stored in memory 660 and/or storage 665.

Sensor and camera circuitry 650 may capture still, and video images that may be processed in accordance with this disclosure, at least in part, by video codec(s) 655 and/or processor 605 and/or graphics hardware 620, and/or a dedicated image processing unit incorporated within circuitry 650. Images captured may be stored in memory 660 and/or storage 665. Memory 660 may include one or more different types of media used by processor 605 and graphics hardware 620 to perform device functions. For example, memory 660 may include memory cache, read-only memory (ROM), and/or random access memory (RAM). Storage 665 may store media (e.g., audio, image and video files), computer program instructions or software, preference information, device profile information, and any other suitable data. Storage 665 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 660 and storage 665 may be used to tangibly retain computer program instructions, or code organized into one or more modules and written in any desired computer programming language. When executed by, for example, processor 605 such computer program code may implement one or more of the methods described herein.

Various processes defined herein consider the option of obtaining and utilizing a user's identifying information. For example, such personal information may be utilized in order to track motion by the user. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-4 or the arrangement of elements shown in FIGS. 1, and 5-6 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining hand tracking data for a hand based on one or more camera frames;
detecting, at a first frame, a change in motion characteristics of the hand satisfies a threshold change in motion characteristics;
detecting, at a second frame, a change in hand gesture status;
determining that the second frame is within a threshold time period of the first frame; and
in response to the determination, adjusting a hand location for a user input action associated with the change in hand gesture status in accordance with a hand location at the first frame.

2. The method of claim 1, wherein the user input action is a markup action comprising adding or removing a markup on a user interface in accordance with the change in motion characteristics.

3. The method of claim 2, wherein the first frame is captured before the second frame, and wherein the change in hand gesture status comprises a transition from a pinch to an unpinch, the method further comprising, in response to the determination:
removing markup on the user interface from a location on the user interface associated with a hand location in the first frame to a location on the user interface associated with the hand location in the second frame.

4. The method of claim 2, wherein the first frame is captured after the second frame, and wherein the change in hand gesture status comprises a transition from an unpinch to a pinch, the method further comprising, in response to the determination:
removing markup on the user interface from a location on the user interface associated with the hand location in the first frame to a location on the user interface the hand location associated with the second frame.

5. The method of claim 4, wherein removing markup comprises:
obtaining historic hand locations for frames captured between the first frame and the second frame; and
removing markup on the user interface in accordance with the historic hand locations.

6. The method of claim 2, wherein the first frame is captured after the second frame, and wherein the change in hand gesture status comprises a transition from a pinch to an unpinch, the method further comprising, in response to the determination:
adding markup on the user interface between a location on the user interface associated with the hand location in the second frame and a location on the user interface associated with the hand location in the first frame.

7. The method of claim 2, wherein the first frame is captured before the second frame, and wherein the change in hand gesture status comprises a transition from an unpinch to a pinch, the method further comprising, in response to the determination:
adding markup on the user interface between a location on the user interface associated with the hand location in the second frame and a location on the user interface associated with the hand location in the first frame.

8. The method of claim 7, wherein adding markup comprises:
obtaining historic hand locations for frames captured between the first frame and the second frame; and
adding the markup on the user interface in accordance with the historic hand locations.

9. A non-transitory computer readable medium comprising computer readable code executable by one or more processors to:
obtain hand tracking data for a hand based on one or more camera frames;
detect, at a first frame, a change in motion characteristics of the hand satisfies a threshold change in motion characteristics;
detect, at a second frame, a change in hand gesture status;
determine that the second frame is within a threshold time period of the first frame; and
in response to the determination, adjust a hand location for a user input action associated with the change in hand gesture status in accordance with a hand location at the first frame.

10. The non-transitory computer readable medium of claim 9, wherein the user input action is a markup action comprising adding or removing a markup on a user interface in accordance with the change in motion characteristics.

11. The non-transitory computer readable medium of claim 10, wherein the first frame is captured after the second frame, and wherein the change in hand gesture status comprises a transition from an unpinch to a pinch, and further comprising computer readable code to, in response to the determination:
remove markup on the user interface from a location on the user interface associated with the hand location in the first frame to a location on the user interface the hand location associated with the second frame.

12. The non-transitory computer readable medium of claim 10, wherein the first frame is captured after the second frame, and wherein the change in hand gesture status comprises a transition from a pinch to an unpinch, and further comprising computer readable code to, in response to the determination:
add markup on the user interface between a location on the user interface associated with the hand location in the second frame and a location on the user interface associated with the hand location in the first frame.

13. The non-transitory computer readable medium of claim 10, wherein the first frame is captured before the second frame, and wherein the change in hand gesture status comprises a transition from an unpinch to a pinch, and further comprising computer readable code to, in response to the determination:
add markup on the user interface between a location on the user interface associated with the hand location in the second frame and a location on the user interface associated with the hand location in the first frame.

14. The non-transitory computer readable medium of claim 13, wherein the computer readable code to add markup comprises computer readable code to:
obtain historic hand locations for frames captured between the first frame and the second frame; and
add the markup on the user interface in accordance with the historic hand locations.

15. A system comprising:
one or more processors; and
one or more computer readable media comprising computer readable code executable by the one or more processors to:
obtain hand tracking data for a hand based on one or more camera frames;
detect, at a first frame, a change in motion characteristics of the hand satisfies a threshold change in motion characteristics;
detect, at a second frame, a change in hand gesture status;
determine that the second frame is within a threshold time period of the first frame; and
in response to the determination, adjust a hand location for a user input action associated with the change in hand gesture status in accordance with a hand location at the first frame.

16. The system of claim 15, wherein the user input action is a markup action comprising adding or removing a markup on a user interface in accordance with the change in motion characteristics.

17. The system of claim 16, wherein the first frame is captured before the second frame, and wherein the change in hand gesture status comprises a transition from a pinch to an unpinch, and further comprising computer readable code to, in response to the determination:
remove markup on the user interface from a location on the user interface associated with a hand location in the first frame to a location on the user interface associated with the hand location in the second frame.

18. The system of claim 16, wherein the computer readable code to remove the markup comprises computer readable code to:
obtain historic hand locations for frames captured between the first frame and the second frame; and
remove markup on the user interface in accordance with the historic hand locations.

19. The system of claim 16, wherein the first frame is captured after the second frame, and wherein the change in hand gesture status comprises a transition from a pinch to an unpinch, and further comprising computer readable code to, in response to the determination:
add markup on the user interface between a location on the user interface associated with the hand location in the second frame and a location on the user interface associated with the hand location in the first frame.

20. The system of claim 16, wherein the first frame is captured before the second frame, and wherein the change in hand gesture status comprises a transition from an unpinch to a pinch, and further comprising computer readable code to, in response to the determination:
add markup on the user interface between a location on the user interface associated with the hand location in the second frame and a location on the user interface associated with the hand location in the first frame.
